(19) United States
(12) Patent Application Publication
(10) Pub. No.: US 2013/0188219 A1
(43) Pub. Date: Jul. 25, 2013

(54) PRINT SYSTEM AND PRINT SERVER

(71) Applicants: Toshihiro Ida, Shizuoka-ken (JP); Kazuhiro Ogura, Kanagawa-ken (JP); Shinji Makishima, Shizuoka-ken (JP); Akihiro Mizutani, Shizuoka-ken (JP); Yusuke Hamada, Shizuoka-ken (JP)

(72) Inventors: Toshihiro Ida, Shizuoka-ken (JP); Kazuhiro Ogura, Kanagawa-ken (JP); Shinji Makishima, Shizuoka-ken (JP); Akihiro Mizutani, Shizuoka-ken (JP); Yusuke Hamada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/693,257

(22) Filed: Dec. 4, 2012

Related U.S. Application Data
(60) Provisional application No. 61/577,182, filed on Dec. 19, 2011.

(51) Int. Cl. H04N 1/32

(52) U.S. Cl. CPC H04N 1/32144
USPC 358/1.15

(57) ABSTRACT

According to one embodiment, a print system includes a client computer connected to a network and configured to generate a document as a print job, a print server connected to the network and configured to store, as an updated print job, the document generated by the client computer and additional information added to the document, a viewing terminal connected to the network and used to view the document stored in the print server and add information to the document, and a printer configured to print the document together with the added information according to a printing instruction.

### CROSS-REFERENCE TO RELATED APPLICATIONS

This application is based upon and claims the benefit of priority from U.S. Provisional Application No. 61/577,182 filed on Dec. 19, 2011; the entire contents of which are incorporated herein by reference.

### FIELD

Embodiments described herein relate generally to a print system and a print server.

### BACKGROUND

In the related art, when printing is performed using a printer connected to a network, the printing is performed via a print server. Recently, portable terminals of a tablet type are rapidly spreading.

Because of such a background, a system is put to practical use in which, for example, in a seminar, tablet terminals are distributed to seminar participants and the seminar participants view, via the distributed tablet terminals, a document for presentation stored in a print server in advance.

The system has an advantage that the participants can freely view a material used for presentation in the seminar and can write notes and the like in the material.

However, if the participants write notes in the presentation material displayed by the tablet terminals, there is a disadvantage that written contents may not be able to be reflected on output print sheets.

### BRIEF DESCRIPTION OF THE DRAWINGS

FIG. 1 is a block diagram of the configuration of a print system;

FIG. 2 is a block diagram of the configuration of a print server;

FIG. 3 is a block diagram of the configuration of a client computer;

FIG. 4 is a block diagram of the configuration of a printer;

FIG. 5 is a diagram of a data structure of a per-user job management database;

FIG. 6 is a diagram of an example of stored data of a document basic information file;

FIG. 7 is a diagram of a data structure of a group job management database;

FIG. 8 is a diagram of an example of stored data of a group basic information file;

FIG. 9 is a diagram of a data structure of an additional information database used when group management is not performed;

FIG. 10 is a diagram of a data structure of an additional information database used when group management is performed;

FIG. 11 is a flowchart for explaining a group setting operation;

FIG. 12 is a flowchart for explaining a print job generating operation;

FIG. 13 is a flowchart for explaining an operation for adding information to a document; and

FIG. 14 is a flowchart for explaining an operation for printing a document together with additional information.

### DETAILED DESCRIPTION

There is a demand for a print system and a print server with which a user not only can view a document stored in a print server but also can freely add information to the document and print the document together with the added information.

In general, according to one embodiment, a print system includes: a client computer connected to a network and configured to generate a document as a print job; a print server connected to the network and configured to store, as an updated print job, the document generated by the client computer and additional information added to the document; a viewing terminal connected to the network and used to view the document stored in the print server and add the additional information to the document; and a printer configured to print the document together with the additional information according to a printing instruction.

A print system and a print server according to an embodiment are explained below with reference to the accompanying drawings.

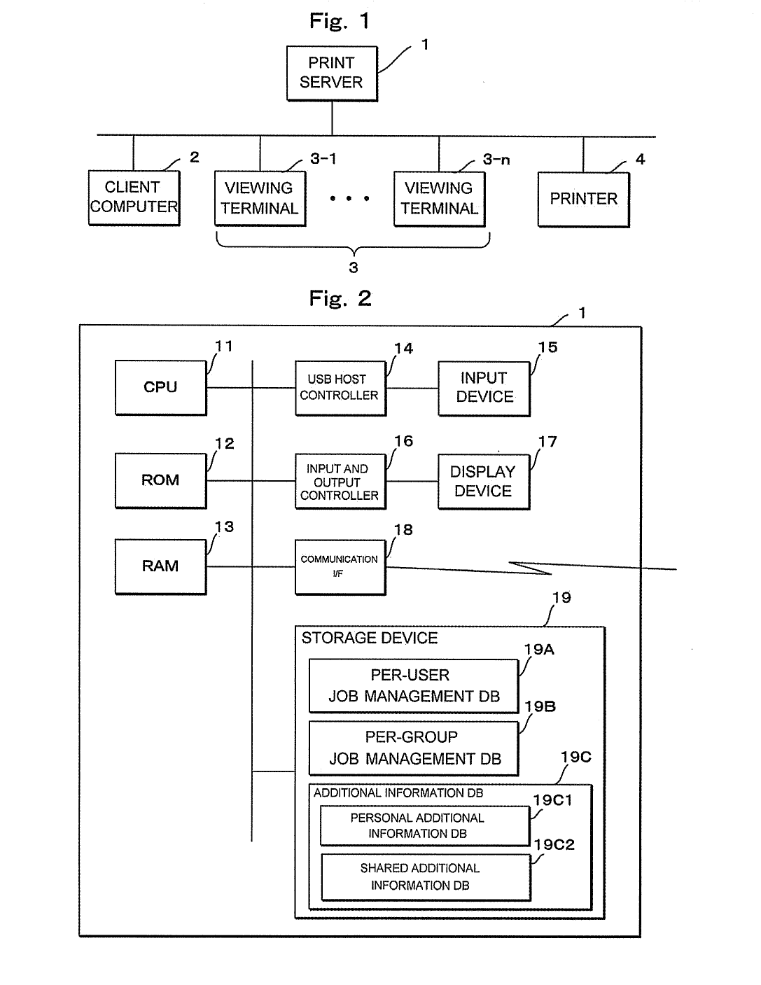

FIG. 1 is a block diagram of the configuration of a print system according to this embodiment. As shown in FIG. 1, the print system according to this embodiment includes a client computer 2 connected to a network and configured to generate a document as a print job, a print server 1 connected to the network and configured to store, as an updated print job, the document generated by the client computer 2 and additional information added to the document, a viewing terminal 3 connected to the network and used to view the document stored in the print server 1 and add information to the document, and a printer 4 configured to print the document together with the added information according to a printing instruction.

The client computer 2 may be a desktop computer, a notebook computer, a tablet computer, or a smartphone.

The viewing terminal 3 and the client computer 2 may be computers having the same configuration or computers having different configurations. It is advantageous in terms of operation that the viewing terminal 3 is a tablet terminal.

A plurality of viewing terminals 3 may be connected to the network.

FIG. 2 is a block diagram of the configuration of the print server 1. As shown in FIG. 2, the print server 1 is a so-called server computer. The print server 1 includes a CPU 11, which is an arithmetic unit, a ROM 12 and a RAM 13, which are memories, an input device 15 such as a keyboard or a mouse connected via, for example, a USB host controller 14, a display device 17 such as a display or a touch panel connected via an input and output controller 16, a communication interface (interface is hereinafter referred to as I/F) 18 connected to a network, and a nonvolatile storage device 19 such as a hard disk drive.

The storage device 19 includes a per-user job management database (database is hereinafter referred to as DB) 19A that stores a print job for each of users, a per-group job management DB 19B that stores a print job for each of groups, and an additional information DB 19C that stores additional information, which is added from the viewing terminal 3, for each of print jobs.

The storage device 19 may include only one of the per-user job management DB 19A and the per-group job management DB 19B.

The storage device 19 may include the per-user job management DB 19A and the per-group job management DB 19B as one database.

Further, the storage device 19 stores an instruction readable by a computer. The print server 1 reads the instruction and executes the instruction using the CPU 11.

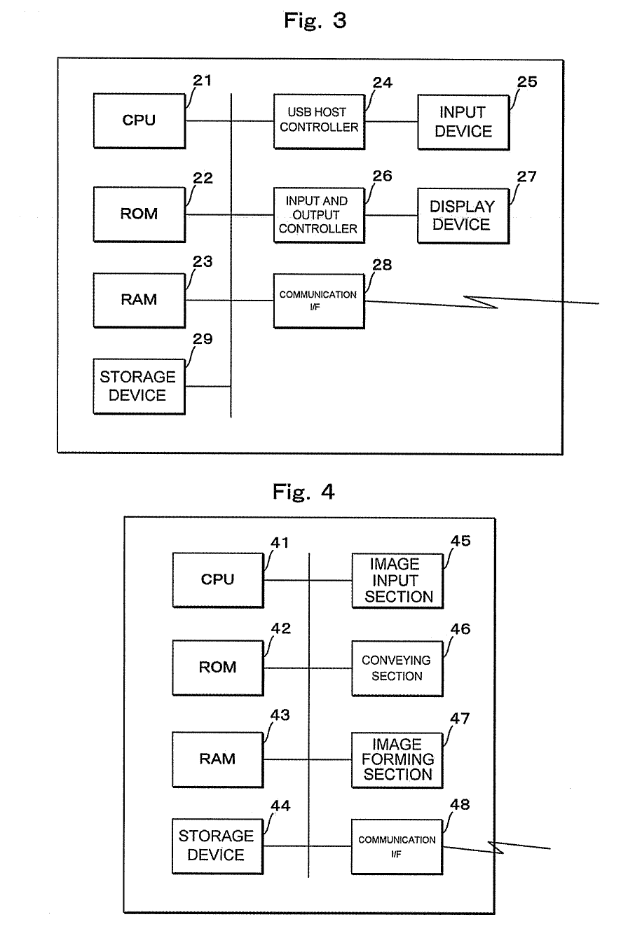

FIG. 3 is a block diagram of the configuration of the client computer 2. As shown in FIG. 3, the client computer 2 includes a CPU 21, which is an arithmetic unit, a ROM 22 and a RAM 23, which are memories, an input device 25 such as a keyboard or a mouse connected via, for example, a USB host controller 24, a display device 27 such as a display or a touch panel connected via an input and output controller 26, a communication I/F 28 connected to the network, and a nonvolatile storage device 29 such as a hard disk drive.

The client computer 2 stores, in the storage device 29, a document creation application, which is document creating means, and a printer driver, which is print-job generating means.

The client computer 2 reads the document creating means and the print job generating means from the storage device 29 and executes the means using the CPU 21.

The hardware configuration of the viewing terminal 3 is the same as the hardware configuration of the client computer 2.

The viewing terminal 3 stores, in the storage device 29, an adding application, which is information adding means for viewing a document stored in the print server 1, adding information to the document, and causing the printer 4 to print the document.

The viewing terminal 3 reads the adding application from the storage device 29 and executes the adding application using the CPU 21.

FIG. 4 is a block diagram of the configuration of the printer 4. As shown in FIG. 4, the printer 4 includes a CPU 41, which is an arithmetic unit, a ROM 42 and a RAM 43, which are memories, a nonvolatile storage device 44 such as a hard disk drive, an image input section 45 configured to read an image of an original document, a conveying section 46 configured to convey a sheet, an image forming section 47 configured to form an image on the sheet, and a communication I/F 48 connected to the network.

The printer 4 may further include authenticating means for authenticating a user.

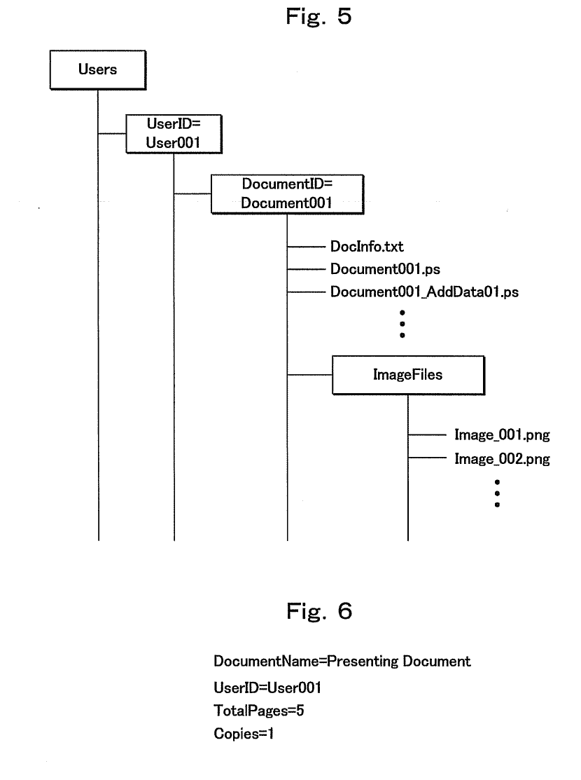

FIG. 5 is a diagram of a data structure of the per-user job management DB 19A. As shown in FIG. 5, the per-user job management DB 19A stores, in DBname=Users, for each of UserIDs peculiarly allocated to the users, a DocumentID, which is an ID peculiarly allocated to each of documents.

The per-user job management DB 19A stores, in lower layers of the DocumentID shown as Document001 in FIG. 5, a document basic information file, in which information concerning a document is stored, shown as DocInfo.txt in FIG. 5, document data, which is stored in a vector format such as PostScript, shown as Document001.ps in FIG. 5, additional information data, which is stored in a vector format such as PostScript, shown as Document001_AddData01.ps in FIG. 5, and an image file for viewing, which is converted into a file viewable on a viewing terminal, shown as ImageFiles in FIG. 5. Examples of the file viewable on the viewing terminal include PNG, JPEG, and PDF. However, the file is not limited to these examples.

As explained above, the document data and the additional information data are stored in the same file format suitable for printing. Therefore, it is possible to simultaneously process the document data and the additional information data when printing data explained below is generated.

FIG. 6 is a diagram of an example of stored data of the document basic information file. As shown in FIG. 6, the document basic information file stores “DocumentName”, which is a name of a document, “UserID”, which is an ID peculiarly allocated to each of users, “TotalPages”, which is a total number of pages of the document, and “Copies” indicating the number of copies.

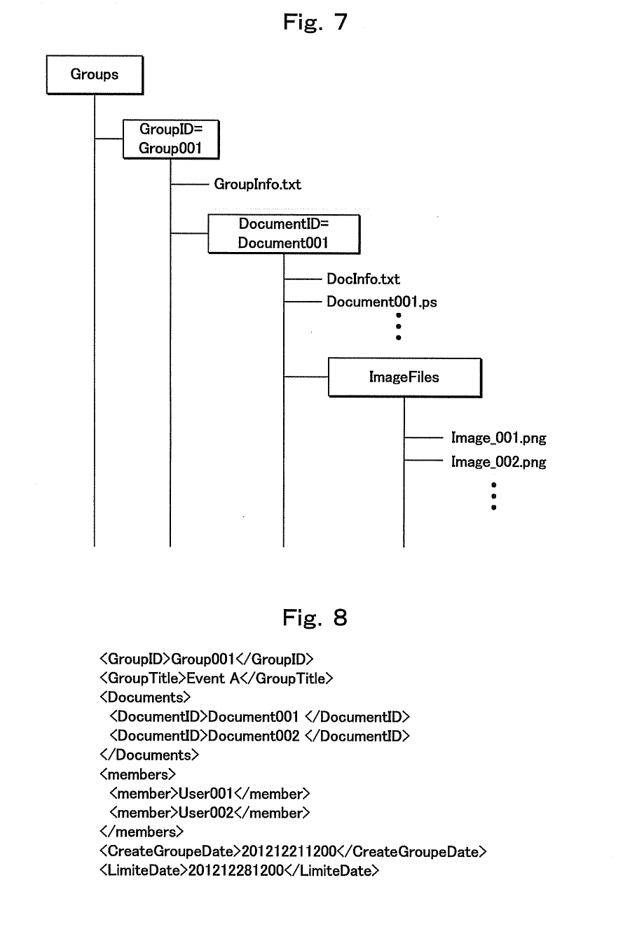

FIG. 7 is a diagram of a data structure of the per-group job management DB 19B. As shown in FIG. 7, the per-group job management DB 19B stores, in DBname=Groups, for each of GroupIDs, a group basic information file, which is information concerning a group, shown as GroupInfo.txt in FIG. 7 and DocumentID.

The per-group job management DB 19B stores, in lower layers of DocumentID shown as Document001 in FIG. 7, a document basic information file, in which information concerning a document is stored, shown as DocInfo.tex in FIG. 7, document data, which is stored in a vector format such as PostScript, shown as Document001.ps in FIG. 7, and an image file for viewing shown as ImageFiles in FIG. 7.

FIG. 8 is a diagram of an example of stored data of the group basic information file. As shown in FIG. 8, the group basic information file stores, in an XML format, <GroupID>, which is an ID peculiarly allocated to each of groups, <GroupTitle>, which is a name of the group, <Documents> in which <DocumentID>, which is an ID peculiarly allocated to each of documents, is stored in lower layers, <members> in which <member>, which is an ID peculiarly allocated to a member of the group, is stored lower layers, <CreateGroupDate> indicating date and time when the group is generated, and <LimiteDate> indicating a term of validity.

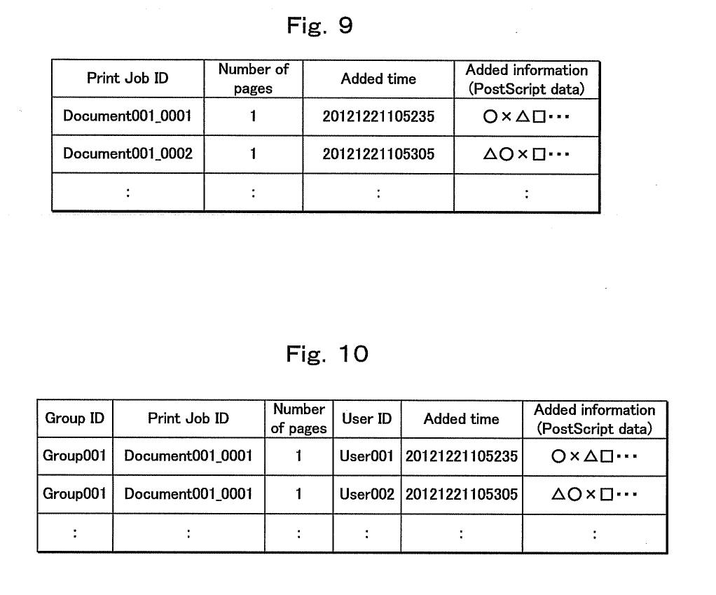

FIG. 9 is a diagram of a data structure of a personal additional information DB 1901 used when group management is not performed. As shown in FIG. 9, the personal additional information DB 1901 stores “Print Job ID”, which is an ID peculiarly allocated to each of print jobs and includes DocumentID, “Number of pages” indicating the number of added pages, “Added time” indicating date and time when additional information is added, and “Added information”, which is additional information described by vector data such as PostScript.

The Print Job ID includes DocumentID. Therefore, it is possible to identify a document, to which information is added, according to the DocumentID.

FIG. 10 is a diagram of a data structure of a shared additional information DB 1902 used when group management is performed. As shown in FIG. 10, the shared additional information DB 1902 stores “GroupID”, which is an ID peculiarly allocated to each of groups, “Print Job ID”, which is an ID peculiarly allocated to each of print jobs and includes DocumentID, “Number of pages” indicating the number of added pages, “User ID” peculiarly allocated to each of users, “Added time” indicating date and time when additional information is added, and “Added information”, which is additional information described by vector data such as PostScript.

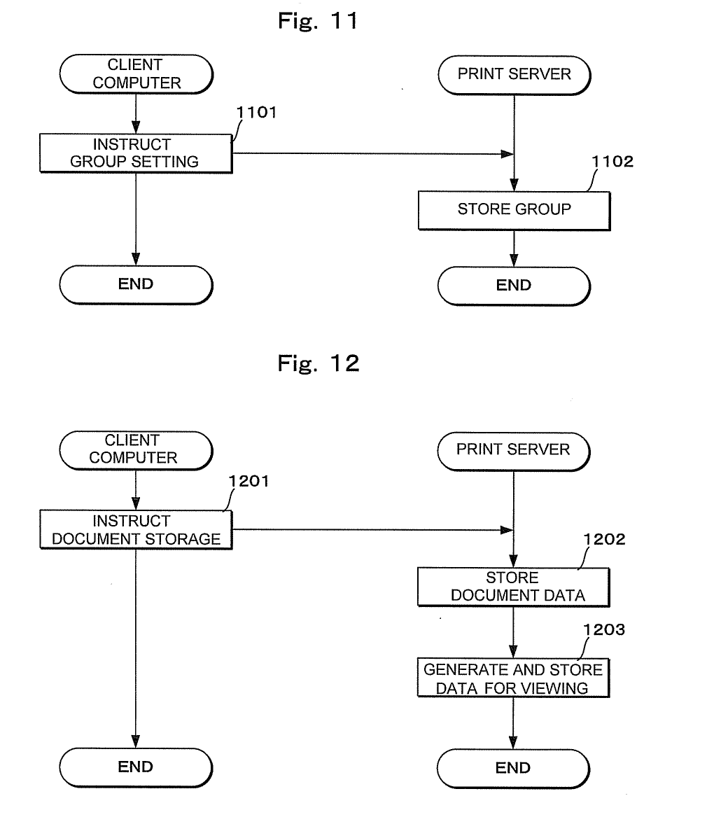

FIG. 11 is a flowchart for explaining a group setting operation. As shown in FIG. 11, in Act 1101, the client computer 2 transmits an instruction for group setting to the print server 1.

In Act 1102, the print server 1 stores information concerning a set group in the group basic information file of the per-group job management DB 19B.

FIG. 12 is a flowchart for explaining a print job generating operation. As shown in FIG. 12, in Act 1201, the client computer 2 transmits a document storage instruction to the print server 1 using the print-job generating means.

In Act 1202, the print server 1 stores received document data in the per-user job management DB 19A or the per-group job management DB 19B and generates a document basic information file.

In Act 1203, the print server 1 generates an image file for viewing, which is data for viewing, and stores the image file for viewing in the per-user job management DB 19A or the per-group job management DB 19B.

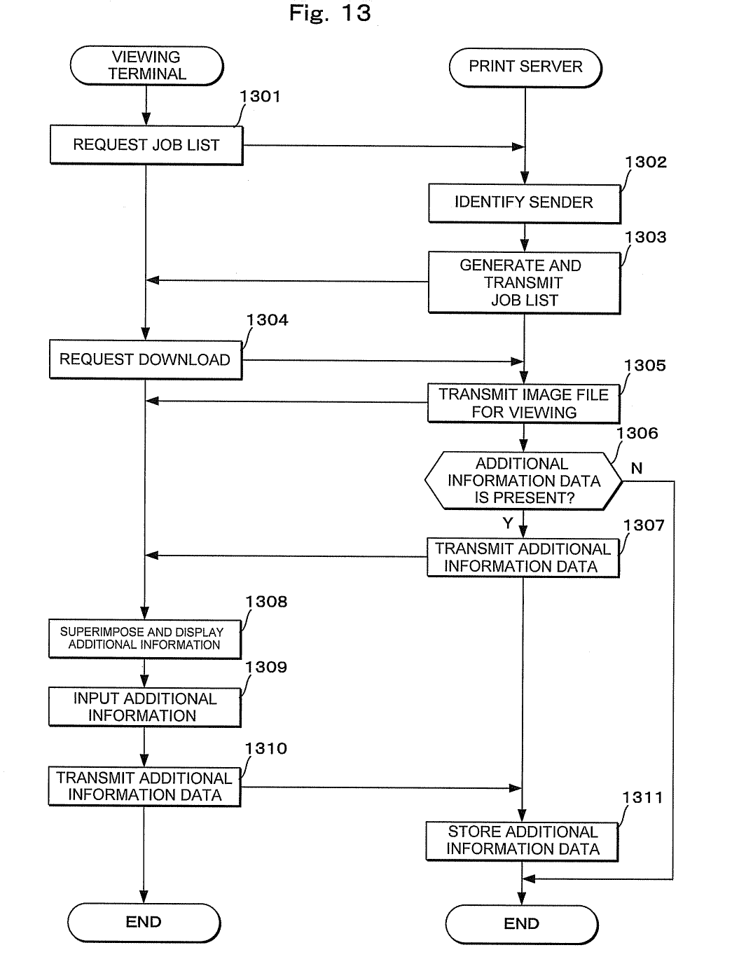

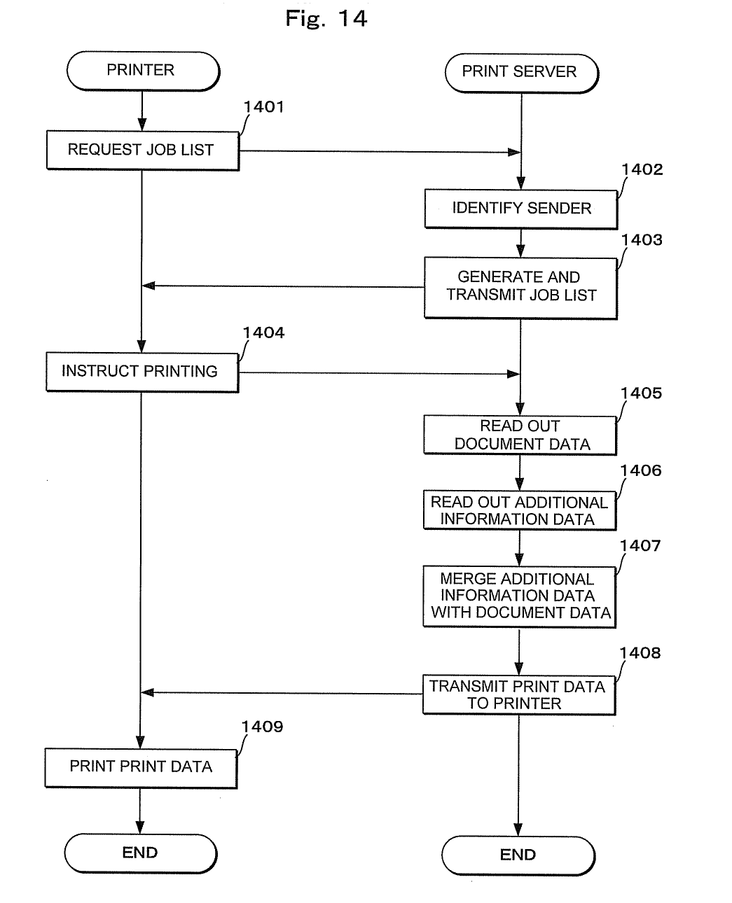

FIG. 13 is a flowchart for explaining an operation for adding information to a document. As shown in FIG. 13, in Act 1301, the viewing terminal 3 transmits a job list request to the print server 1.

In Act 1302, the print server 1 identifies a sender from the received job list request. Specifically, the print server 1 extracts a UserID included in the job list request.

When the print server 1 performs group management, the print server 1 reads out a member from the per-group job management DB 19B on the basis of a GroupID included in the job list request and determines whether the received UserID is included in the member.

In this case, if the print server 1 determines that the received UserID is included in the member, the print server 1 proceeds to Act 1303. If the print server 1 determines that the received UserID is not included in the member, the print server 1 returns an error to the viewing terminal 3.

Therefore, it is possible to permit only members designated in advance to view the document.

In Act 1303, the print server 1 generates a job list from the per-user job management DB 19A and the per-group job management DB 19B on the basis of the UserID and transmits the job list to the viewing terminal 3.

In Act 1304, the viewing terminal 3 transmits, to the print server 1, a download request for a document of a job designated by a user using a DocumentID.

In Act 1305, the print server 1 transmits an image file for viewing to the viewing terminal 3.

In Act 1306, the print server 1 searches through, on the basis of the DocumentID, the per-user job management DB 19A or the per-group job management DB 19B and determines whether additional information data is present in the document.

If there is additional information data, the print server 1 proceeds to Act 1307. If there is no additional information data, the print server 1 ends the processing.

In Act 1307, the print server 1 transmits, to the viewing terminal 3, the additional information data read out from the per-user job management DB 19A or the per-group job management DB 19B.

In Act 1308, the viewing terminal 3 displays the received additional information data while superimposing the additional information data on received document data.

In Act 1309, the viewing terminal 3 further receives additional information data input by the user.

In Act 1310, the viewing terminal 3 transmits the additional information data to the print server 1 in a vector data format such as PostScript.

In Act 1311, the print server 1 stores the received additional information data in a lower layer of a relevant DocumentID of the per-user job management DB 19A or the per-group job management DB 19B and manages the additional information data as an updated print job.

FIG. 14 is a flowchart for explaining an operation for printing a document together with additional information. As shown in FIG. 14, in Act 1401, the printer 4 requests the print server 1 to transmit a job list.

In Act 1402, the print server 1 identifies a sender from the received job list request. Specifically, the print server 1 extracts a UserID included in the job list request.

In Act 1403, the print server 1 generates a job list from the per-user job management DB 19A or the per-group job management DB 19B on the basis of the UserID and transmits the job list to the printer 4.

In Act 1404, the printer 4 transmits a printing instruction for a document of a job designated by a user using a DocumentID to the print server 1.

In Act 1405, the print server 1 reads out document data of the job designated by the DocumentID from the per-user job management DB 19A or the per-group job management DB 19B.

In Act 1406, the print server 1 reads out additional information data of the job designated by the DocumentID from the per-user job management DB 19A or the per-group job management DB 19B.

In Act 1407, the print server 1 generates, as an updated print job, print data in which the additional information data is merged with the document data.

In Act 1408, the print server 1 transmits the printing data to the printer 4. In Act 1409, the printer 4 prints the printing data.

As explained above, the print system according to this embodiment includes the client computer 2 connected to the network and configured to generate a document, the print server 1 connected to the network and including the per-user job management DB 19A and the per-group job management DB 19B that store the document generated by the client computer 2 and the personal additional information DB 1901 and the shared additional information DB 1902 that store additional information, the viewing terminal 3 connected to the network and used to view a document stored in the print server 1 and add information to the document, and a printer 4 configured to print the document together with the added information according to a printing instruction.

Therefore, it is possible to not only view a document stored in the print server but also freely add information to the document and print the document together with the added information.

Further, it is possible to manage document data and additional information data in a common file format. Therefore, it is possible to perform efficient processing.

While certain embodiments have been described, these embodiments have been presented by way of example only, and are not intended to limit the scope of the inventions . Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A print system comprising:
a client computer connected to a network and configured to generate a document as a print job;
a print server connected to the network and configured to store, as an updated print job, the document generated by the client computer and additional information added to the document;
a viewing terminal connected to the network and used to view the document stored in the print server and add the additional information to the document; and
a printer configured to print the document together with the additional information according to a printing instruction.

2. The print system according to claim 1, wherein the viewing terminal displays the additional information while superimposing the additional information on the document downloaded from the print server.

3. The print system according to claim 2, wherein the print server registers a member for each of groups and permits only a member designated in advance to view the document.

4. The print system according to claim 3, wherein the print server includes:
a job management database configured to store the document generated by the client computer; and
an additional information database configured to store the additional information.

5. The print system according to claim 4, wherein the job management database stores the member for each of the groups.

6. A print server connected to a network and configured to store, as an updated print job, a document generated by a client computer as a print job and additional information added by a viewing terminal connected to the network and used to view the document and add the additional information to the document.

7. The print server according to claim 6, wherein the viewing terminal displays the additional information while superimposing the additional information on the document downloaded from the print server.

8. The print server according to claim 7, wherein the print server registers a member for each of groups and permits only a member designated in advance to view the document.

9. The print server according to claim 8, comprising:
a job management database configured to store the document generated by the client computer; and
an additional information database configured to store the additional information.

10. The print server according to claim 9, wherein the job management database stores the member for each of the groups.
